(19) United States
(12) Patent Application Publication
(10) Pub. No.: US 2023/0092969 A1
(43) Pub. Date: Mar. 23, 2023

(54) INCREMENTAL MACHINE LEARNING USING EMBEDDINGS

(71) Applicant: International Business Machines Corporation, Armonk, NY (US)

(72) Inventors: CHAO-MIN CHANG, Taipei City (TW); Bo-Yu Kuo, Kaohsiung (TW); Yu-Jin Chen, New Taipei City (TW); Yu-Chi Tang, New Taipei (TW)

(21) Appl. No.: 17/479,217

(22) Filed: Sep. 20, 2021

(51) Int. Cl. G06N 3/04; G06K 9/62

(52) U.S. Cl. CPC G06N 3/04; G06K 9/6215; G06K 9/6218; G06K 9/6262; G06K 9/628

(57) ABSTRACT

An embodiment of the present invention is directed toward machine learning to produce results encompassing a new output. A machine learning model is trained to determine a candidate output from among a plurality of candidate outputs. First embeddings associated with the plurality of candidate outputs are generated from a first set of training data by an intermediate layer of the trained machine learning model. Second embeddings associated with a new candidate output are generated from a second set of training data by the intermediate layer of the trained machine learning model. A third embedding is determined for input data by the intermediate layer of the trained machine learning model. A resulting candidate output for the input data is predicted from a group of the plurality of candidate outputs and the new candidate output based on distances for the third embedding to the first and second embeddings.

### BACKGROUND

### 1. Technical Field

Present invention embodiments relate to machine learning, and more specifically, to incremental machine learning of a new aspect (e.g., new output, new class, etc.) using embeddings without retraining a machine learning model.

### 2. Discussion of the Related Art

Classification is an area of machine learning that is used for classifying different inputs into a certain number of groups or classes. Classification is widely used in various areas, such as computer vision, natural language processing, and data analysis. Typically, classification models are created with an output layer of a fixed size including a number of nodes that equals the number of classes to predict (e.g., each node of an output layer corresponds to a predicted class).

If a new class is desired for addition to the classification model, the classification model will need to be reconfigured, reset, and retrained in order to include the new class. Accordingly, when the number of classes changes frequently, the classification model will constantly be reconfigured, reset, and retrained.

### SUMMARY

According to one embodiment of the present invention, a system for machine learning to produce results encompassing a new output comprises at least one processor. A machine learning model is trained to determine a candidate output from among a plurality of candidate outputs. First embeddings associated with the plurality of candidate outputs are generated from a first set of training data. The first embeddings are produced from an intermediate layer of the trained machine learning model. Second embeddings associated with a new candidate output are generated from a second set of training data. The second embeddings are produced from the intermediate layer of the trained machine learning model. A third embedding is determined for input data by the intermediate layer of the trained machine learning model. A resulting candidate output for the input data is predicted from a group of the plurality of candidate outputs and the new candidate output based on distances for the third embedding to the first and second embeddings. Embodiments of the present invention further include a method and computer program product for machine learning to produce results encompassing a new output in substantially the same manner described above.

Present invention embodiments enable a new candidate output to be learned based on training data for that candidate output and without retraining the machine learning model, thereby conserving computing and memory resources and significantly increasing the speed of machine learning.

An embodiment of the present invention may employ a classification model as the machine learning model, where the plurality of candidate outputs includes classes, and the new candidate output includes a new class. This enables new classes to be added for classification without retraining the classification model, thereby improving computing performance especially for cases where classes change frequently.

An embodiment of the present invention may further predict the resulting candidate output by determining, from the first and second embeddings, a plurality of embeddings closest to the third embedding and determining the resulting candidate output based on candidate outputs associated with the determined plurality of embeddings. The embeddings and prediction are used in order to add new candidate outputs without retraining the machine learning model. The use of the embeddings (and the distances therebetween) further provides sufficient accuracy of the prediction to avoid retraining.

An embodiment of the present invention may also determine the resulting candidate output based on a candidate output associated with a majority of the determined plurality of embeddings. The use of the majority ensures an appropriate (and closest) candidate output is selected for enhancing accuracy of the prediction to avoid retraining the machine learning model.

An embodiment of the present invention may further determine a training score based on the first and second embeddings and retrain the machine learning model in response to the training score failing to satisfy a threshold. This enables the performance of the embeddings to be monitored to selectively trigger embedding retraining to increase the performance of the embeddings. Thus, the frequency of training the machine learning model can be significantly decreased, thereby improving computer performance.

An embodiment of the present invention may also have the first embeddings form a plurality of first clusters each associated with a corresponding candidate output and the second embeddings form a second cluster associated with the new candidate output. In this case, the training score may be determined based on distances between the second embeddings within the second cluster and distances between each of the second embeddings and the plurality of first clusters. This enables the performance of the embeddings to be monitored based on quality of the cluster formed by the embeddings for the new candidate output. When the cluster for the new candidate output is insufficient to distinguish the new candidate output from the plurality of candidate outputs, embedding retraining is conducted to increase the performance of the embeddings. Thus, the frequency of training the machine learning model can be significantly decreased, thereby improving computer performance.

In an embodiment of the present invention, the machine learning model comprises a neural network including an input layer, the intermediate layer, and an output layer for the plurality of candidate outputs, and the first, second, and third embeddings are generated by an embedding model. The embedding model includes the neural network of the trained machine learning model without the output layer. This structurally changes the neural network to form an embedding model that generates the embeddings based on the trained neural network. The embeddings enable new candidate outputs to be learned without retraining the neural network, thereby significantly increasing the speed of machine learning.

An embodiment of the present invention may also add the new candidate output to the group for predicting the resulting candidate output without retraining the machine learning model. This conserves computing and memory resources and significantly increases the speed of machine learning.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is block diagram of a machine learning system according to an embodiment of the present invention.

FIG. 4 is a graphical illustration of adding a new class by using embeddings generated by an embedding model of the machine learning system of FIG. 3 according to an embodiment of the present invention.

FIG. 5 is a graphical illustration of predicting a class by a prediction model of the machine learning system of FIG. 3 according to an embodiment of the present invention.

FIG. 6 is a procedural flowchart illustrating a manner of learning a new aspect by incremental machine learning according to an embodiment of the present invention.

FIG. 7 is diagrammatic illustration of an example of adding a new class for the machine learning system of FIG. 3 according to an embodiment of the present invention.

FIG. 8 is a graphical illustration of predicting a class for the example of FIG. 7 according to an embodiment of the present invention.

### DETAILED DESCRIPTION

Present invention embodiments are directed to incremental machine learning of a new aspect (e.g., new output, new class, etc.) using embeddings without retraining a machine learning model. For example, when a new class is to be added for a machine learning classification model, the classification model will need to be reconfigured, reset, and retrained in order to include the new class. Accordingly, when the number of classes changes frequently, the classification model will constantly be reconfigured, reset, and retrained, thereby consuming significant computing and memory resources. However, present invention embodiments use embeddings for incremental machine learning (e.g., for deep learning models, classification models, etc.) when a new aspect (e.g., new output, new class, etc.) is added. Thus, incremental machine learning may be performed to learn the new aspect without retraining a machine learning model.

In order to prevent repetitive retraining, present invention embodiments include an embedding model to generate embeddings for data and a prediction model to predict a new added aspect (e.g., new output, new class, etc.) based on the embeddings from the embedding model using pattern recognition. This approach prevents retraining of the embedding model when a new aspect is added.

According to one embodiment of the present invention, a system for machine learning to produce results encompassing a new output comprises at least one processor. A machine learning model is trained to determine a candidate output from among a plurality of candidate outputs. First embeddings associated with the plurality of candidate outputs are generated from a first set of training data. The first embeddings are produced from an intermediate layer of the trained machine learning model. Second embeddings associated with a new candidate output are generated from a second set of training data. The second embeddings are produced from the intermediate layer of the trained machine learning model. A third embedding is determined for input data by the intermediate layer of the trained machine learning model. A resulting candidate output for the input data is predicted from a group of the plurality of candidate outputs and the new candidate output based on distances for the third embedding to the first and second embeddings. Embodiments of the present invention further include a method and computer program product for machine learning to produce results encompassing a new output in substantially the same manner described above.

Present invention embodiments enable a new candidate output to be learned based on training data for that candidate output and without retraining the machine learning model, thereby conserving computing and memory resources and significantly increasing the speed of machine learning.

An embodiment of the present invention may employ a classification model as the machine learning model, where the plurality of candidate outputs includes classes, and the new candidate output includes a new class. This has the advantage of adding new classes for classification without retraining the classification model, thereby improving performance especially for cases where classes change frequently.

An embodiment of the present invention may further predict the resulting candidate output by determining, from the first and second embeddings, a plurality of embeddings closest to the third embedding and determining the resulting candidate output based on candidate outputs associated with the determined plurality of embeddings. The embeddings and prediction are used in order to add new candidate outputs without retraining the machine learning model. The use of the embeddings (and the distances therebetween) further provides sufficient accuracy of the prediction to avoid retraining.

An embodiment of the present invention may also determine the resulting candidate output based on a candidate output associated with a majority of the determined plurality of embeddings. The use of the majority ensures an appropriate (and closest) candidate output is selected for enhancing accuracy of the prediction to avoid retraining the machine learning model.

An embodiment of the present invention may further determine a training score based on the first and second embeddings and retrain the machine learning model in response to the training score failing to satisfy a threshold. This enables the performance of the embeddings to be monitored to selectively trigger embedding retraining to increase the performance of the embeddings. Thus, the frequency of training the machine learning model can be significantly decreased, thereby improving computer performance.

An embodiment of the present invention may also have the first embeddings form a plurality of first clusters each associated with a corresponding candidate output and the second embeddings form a second cluster associated with the new candidate output. In this case, the training score may be determined based on distances between the second embeddings within the second cluster and distances between each of the second embeddings and the plurality of first clusters. This enables the performance of the embeddings to be monitored based on quality of the cluster formed by the embeddings for the new candidate output. When the cluster for the new candidate output is insufficient to distinguish the new candidate output from the plurality of candidate outputs, embedding retraining is conducted to increase the performance of the embeddings. Thus, the frequency of training the machine learning model can be significantly decreased, thereby improving computer performance.

In an embodiment of the present invention, the machine learning model comprises a neural network including an input layer, the intermediate layer, and an output layer for the plurality of candidate outputs, and the first, second, and third embeddings are generated by an embedding model. The embedding model includes the neural network of the trained machine learning model without the output layer. This structurally changes the neural network to form an embedding model that generates the embeddings based on the trained neural network. The embeddings enable new candidate outputs to be learned without retraining the neural network, thereby significantly improving the speed of machine learning.

An embodiment of the present invention may also add the new candidate output to the group for predicting the resulting candidate output without retraining the machine learning model. This conserves computing and memory resources and significantly increases the speed of machine learning.

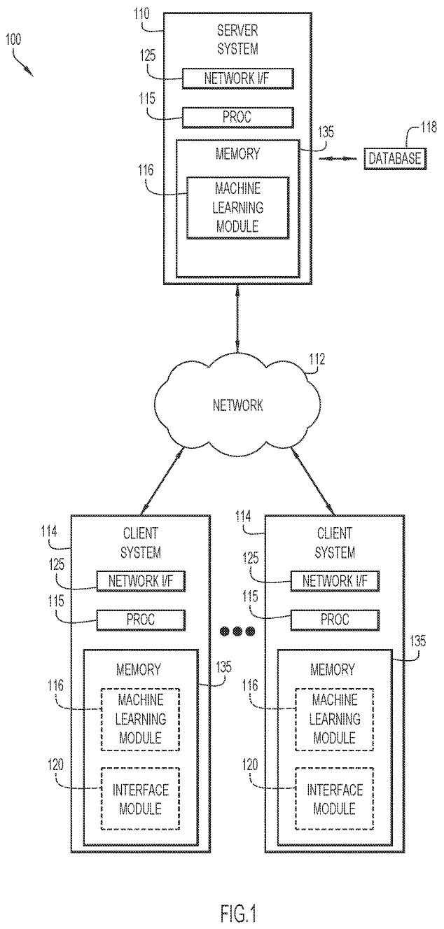

An example environment 100 for use with present invention embodiments is illustrated in FIG. 1. Specifically, the environment includes one or more server systems 110, and one or more client or end-user systems 114. Server systems 110 and client systems 114 may be remote from each other and communicate over a network 112. The network may be implemented by any number of any suitable communications media (e.g., wide area network (WAN), local area network (LAN), Internet, Intranet, etc.). Alternatively, server systems 110 and client systems 114 may be local to each other, and communicate via any appropriate local communication medium (e.g., local area network (LAN), hardwire, wireless link, Intranet, etc.).

Client systems 114 enable users to submit information (e.g., inputs for machine learning models, new aspects (e.g., new outputs, new classes, etc.) for machine learning models, training data, etc.) to server systems 110 to manage and utilize machine learning models to produce outputs for a desired task (e.g., classification, etc.). The server systems include a machine learning module 116 to train, utilize, and maintain machine learning models for various tasks (e.g., classification, etc.) as described below. A database system 118 may store various information for the tasks (e.g., machine learning models and corresponding configurations and parameters, training data, results, etc.). The database system may be implemented by any conventional or other database or storage unit, may be local to or remote from server systems 110 and client systems 114, and may communicate via any appropriate communication medium (e.g., local area network (LAN), wide area network (WAN), Internet, hardwire, wireless link, Intranet, etc.). The client systems may include an interface module 120 or browser to present a graphical user (e.g., GUI, etc.) or other interface (e.g., command line prompts, menu screens, etc.) to solicit information from users (e.g., inputs for machine learning models, new aspects (e.g., new outputs, new classes, etc.) for machine learning models, training data, etc.), and may provide reports including results (e.g., classification, outputs from the machine learning models, etc.).

Server systems 110 and client systems 114 may be implemented by any conventional or other computer systems preferably equipped with a display or monitor, a base, optional input devices (e.g., a keyboard, mouse or other input device), and any software (e.g., conventional or other server/communications software, conventional or other browser software, machine learning module 116 and interface module 120 of present invention embodiments, etc.). The base may include at least one hardware processor 115 (e.g., microprocessor, controller, central processing unit (CPU), etc.), one or more memories 135 and/or internal or external network interfaces or communications devices 125 (e.g., modem, network cards, etc.).

Alternatively, one or more client systems 114 may manage and utilize machine learning models to produce outputs for a desired task (e.g., classification, etc.) when operating as a stand-alone unit. In a stand-alone mode of operation, the client system stores or has access to the data (e.g., inputs for machine learning models, new aspects (e.g., new outputs, new classes, etc.) for machine learning models, training data, machine learning models and corresponding configurations and parameters, training data, results, etc.), and includes machine learning module 116 to train, utilize, and maintain machine learning models for various tasks (e.g., classification, etc.) as described below. Interface module 120 may generate the graphical user (e.g., GUI, etc.) or other interface (e.g., command line prompts, menu screens, etc.) to solicit information from a corresponding user (e.g., inputs for machine learning models, new aspects (e.g., new outputs, new classes, etc.) for machine learning models, training data, etc.), and provide reports including results (e.g., classification, outputs from the machine learning models, etc.).

Machine learning module 116 and interface module 120 may include one or more modules or units to perform the various functions of present invention embodiments described below. The various modules (e.g., machine learning module 116, interface module 120, etc.) may be implemented by any combination of any quantity of software and/or hardware modules or units, and may reside within memory 135 of the server and/or client systems for execution by processor 115.

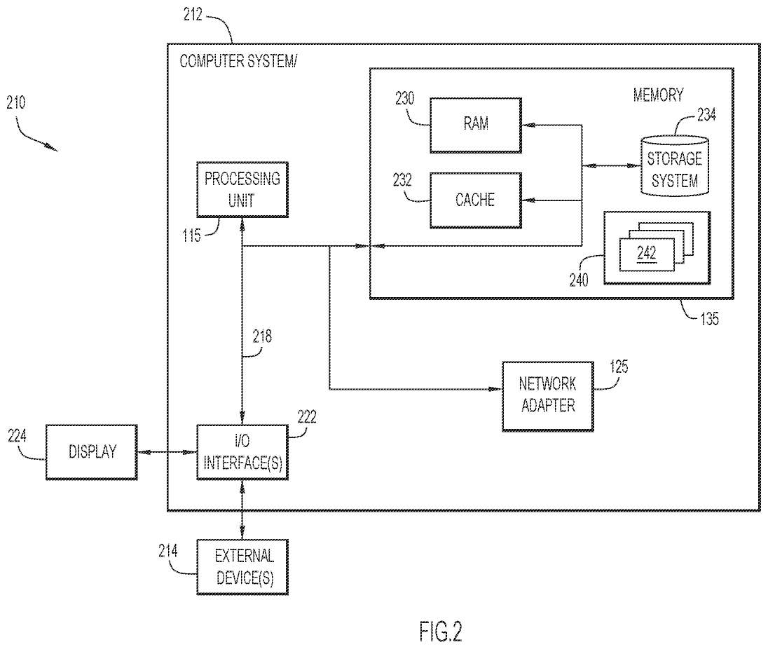

Referring now to FIG. 2, a schematic of an example of a computing device 210 of computing environment 100 (e.g., implementing server system 110, client system 114, database system 118, and/or other computing devices) is shown. The computing device is only one example of a suitable computing device for computing environment 100 and is not intended to suggest any limitation as to the scope of use or functionality of embodiments of the invention described herein. Regardless, computing device 210 is capable of being implemented and/or performing any of the functionality set forth herein.

In computing device 210, there is a computer system 212 which is operational with numerous other general purpose or special purpose computing system environments or configurations. Examples of computing systems, environments, and/or configurations that may be suitable for use with computer system 212 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 212 may be described in the general context of computer system executable instructions, such as program modules, being executed by a computer system. Generally, program modules may include routines, programs, objects, components, logic, data structures, and so on that perform particular tasks or implement particular abstract data types.

As shown in FIG. 2, computer system 212 is shown in the form of a general-purpose computing device. The components of computer system 212 may include, but are not limited to, one or more processors or processing units 115, a system memory 135, and a bus 218 that couples various system components including system memory 135 to processor 115.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 212 typically includes a variety of computer system readable media. Such media may be any available media that is accessible by computer system 212, and it includes both volatile and non-volatile media, removable and non-removable media.

System memory 135 can include computer system readable media in the form of volatile memory, such as random access memory (RAM) 230 and/or cache memory 232. Computer system 212 may further include other removable/non-removable, volatile/non-volatile computer system storage media. By way of example only, storage system 234 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 135 may include at least one program product having a set (e.g., at least one) of program modules that are configured to carry out the functions of embodiments of the invention.

Program/utility 240, having a set (at least one) of program modules 242 (e.g., machine learning module 116, interface module 120, etc.) may be stored in memory 135 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein.

Computer system 212 may also communicate with one or more external devices 214 such as a keyboard, a pointing device, a display 224, etc.; one or more devices that enable a user to interact with computer system 212; and/or any devices (e.g., network card, modem, etc.) that enable computer system 212 to communicate with one or more other computing devices. Such communication can occur via Input/Output (I/O) interfaces 222. Still yet, computer system 212 can communicate with one or more networks such as a local area network (LAN), a general wide area network (WAN), and/or a public network (e.g., the Internet) via network adapter 125. As depicted, network adapter 125 communicates with the other components of computer system 212 via bus 218. It should be understood that although not shown, other hardware and/or software components could be used in conjunction with computer system 212. Examples, include, but are not limited to: microcode, device drivers, redundant processing units, external disk drive arrays, RAID systems, tape drives, and data archival storage systems, etc.

A conventional machine learning classification model may be trained to classify data into a quantity or number of different classes. By way of example, the classification model may be trained to classify the data among one-hundred (100) different classes, where the training set includes ten-thousand (10,000) data items for each class (or 100 classes×10,000 data items=1 million (1,000,000) total data items). The classification model includes an output layer with one-hundred nodes each corresponding to a class.

When an additional class is to be added for the trained classification model, a new classification model is needed with an output layer having one-hundred and one (101) nodes for the one-hundred and one (101) classes. In addition, the new classification model will need to be trained for the one-hundred and one (101) classes with the initial training set for the one-hundred (100) classes and an additional training set (of 10,0000 data items) for the new class (or 101 classes×10,000 data items=1,010,000 total data items). Accordingly, as the number of classes changes, the classification model will need to be reconfigured and retrained (e.g., with a training set in excess of one million (1,000,000) data items) that consumes significant computing and memory resources.

Accordingly, present invention embodiments use embeddings for incremental machine learning (e.g., for deep learning models, classification models, etc.) when a new aspect (e.g., new output, new class, etc.) is added. The incremental machine learning may be performed for the new aspect without retraining a machine learning model. In the case of the above example, an embedding model of a machine learning system of a present invention embodiment is initially trained for the one-hundred (100) classes and modified to produce embeddings. When a new class is to be added, a training set of the new class (e.g., 10,000 data items) is applied to the embedding model to produce embeddings that define the new class and enable a prediction model of the machine learning system to predict the new class as an output. Thus, the new class is added without reconfiguring and retraining the embedding model with the training set for one-hundred and one (101) classes, thereby conserving computing and memory resources and significantly increasing the speed of machine learning. In addition, present invention embodiments introduce flexibility and scalability with respect to handling frequently changing classes.

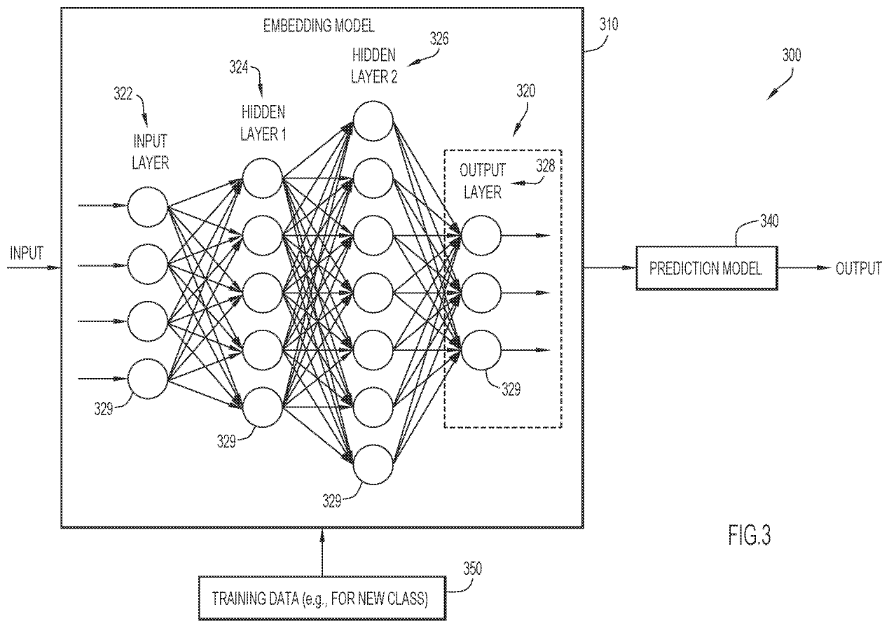

A machine learning system according to an embodiment of the present invention is illustrated in FIG. 3. In particular, a machine learning system 300 receives input data and produces an output indicating one or more from among a plurality of candidate outputs. By way of example, the machine learning system may be a classifier that classifies input data pertaining to an object (e.g., image, text, etc.) into one or more classes, groups, or categories.

Machine learning system 300 includes an embedding model 310 and a prediction model 340. Embedding model 310 receives the input data to the machine learning system and produces an embedding for each data item of the input data. The prediction model applies pattern recognition to the embedding from embedding model 310 to produce as output a predicted candidate output (e.g., class, etc.) for the data item corresponding to the embedding.

Embedding model 310 includes a machine learning model 320 to produce the embeddings. Basically, a data item may be represented by an embedding that includes a vector having numeric elements corresponding to a plurality of dimensions. Data items with similar features or characteristics have similar embeddings or vector representations. By way of example, machine learning model 320 may be implemented by a neural network to produce the emdeddings. The neural network includes an input layer 322, intermediate or hidden layers 324, 326, and an output layer 328. Each layer includes one or more neurons or nodes 329, where the input layer neurons receive input data (e.g., data pertaining to objects), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks, etc.).

The weight (and bias) values may be adjusted based on various training techniques. For example, the training may be performed with data items of the training set as input and corresponding known results as outputs, where the neural network attempts to produce the known results and uses an error from the output (e.g., difference between produced and known outputs) to adjust weight (and bias) values (e.g., via backpropagation or other training techniques). The output layer of the neural network preferably includes a neuron 329 for each candidate output (e.g., class, etc.) and indicates the candidate output for corresponding input data. By way of example, the output layer neurons may indicate a specific candidate output (e.g., class, etc.) or an identifier of the specific candidate output. Further, output layer neurons may indicate a probability of the associated candidate output (e.g., class, etc.) being the result for the input data. The candidate output (e.g., class, etc.) associated with the highest probability is preferably selected for the input data. However, machine learning model 320 may include any quantity of any type of machine learning models (e.g., feed-forward, recurrent, convolutional or other neural networks, etc.). Further, the neural network may include any quantity of layers having any quantity of neurons or nodes.

Neural network 320 is initially trained on a training set for an initial set of candidate outputs (e.g., classes, etc.). Once trained, output layer 328 is removed from the neural network (e.g., to form or serve as embedding model 310), and the preceding intermediate layer 326 serves as an embedding layer that produces the embeddings. The elements or dimensions of the embedding correspond to the number of neurons in the embedding layer (e.g., each neuron of the embedding layer provides a value for an element or dimension of the embedding). However, the embeddings may include any quantity of elements or dimensions pertaining to any desired features (e.g., image features, textual features, etc.).

When a new candidate output (e.g., class, etc.) is to be added, embedding model 310 is provided with training data 350 for the new candidate output to generate embeddings representing and defining the new candidate output that enable prediction model 340 to predict the new candidate output for corresponding input data. Thus, in order to add a new candidate output (e.g., class, etc.), a training set for the new candidate output is applied to the embedding model without retraining of the embedding model, thereby conserving computing and memory resources and significantly increasing the speed of machine learning.

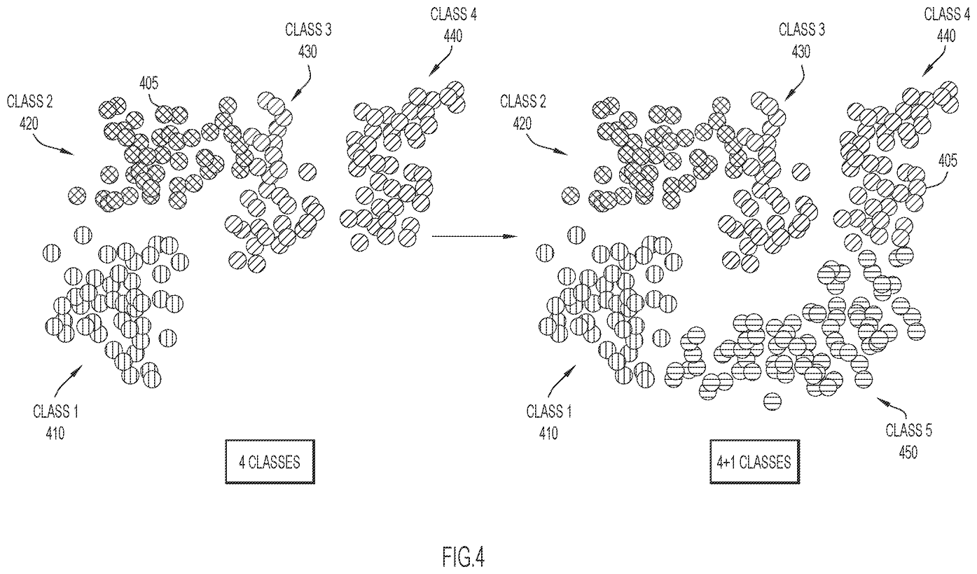

FIG. 4 illustrates an example of data items within a space defined by dimensions of embeddings. Data items 405 are grouped or clustered within the embedding space, thereby forming clusters corresponding to candidate outputs (e.g., classes, etc.). For example, cluster 410 is associated with Class 1, cluster 420 is associated with Class 2, cluster 430 is associated with Class 3, and cluster 440 is associated with Class 4 (e.g., as viewed in FIG. 4). A data item 405 within a cluster is assigned to the class associated with that cluster (e.g., a data item in cluster 410 is assigned to Class 1, a data item in cluster 420 is assigned to Class 2, a data item in cluster 430 is assigned to Class 3, and a data item in cluster 440 is assigned to Class 4). These classes may represent an initial set of classes with which machine learning model 320 (with output layer 328) is trained to provide the embeddings.

When the embedding model is used with the training data for the new class, the resulting embeddings form a new cluster 450 associated with the new class (e.g., Class 5 as viewed in FIG. 4). Clusters 410, 420, 430, 440, and 450 are used by prediction model 340 to predict the candidate output (e.g., class, etc.) for a data item.

Referring back to FIG. 3, the embedding produced from embedding model 310 for a data item is provided to prediction model 340 to produce a predicted candidate output (e.g., class, etc.) for the data item. The prediction model uses pattern recognition techniques (e.g., k nearest neighbor (kNN), etc.) to predict the candidate output (e.g., class, etc.).

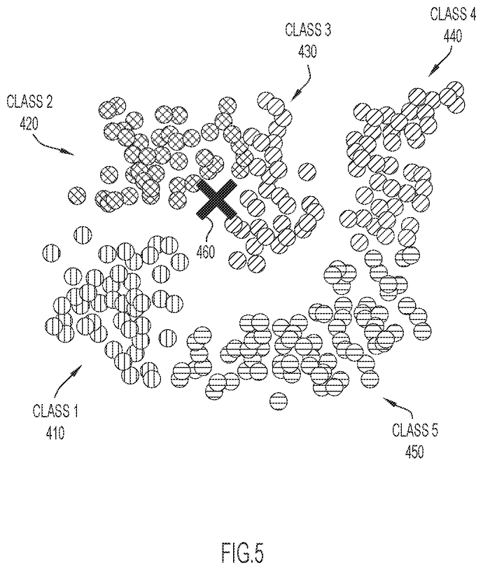

FIG. 5 illustrates an example of prediction model 340 predicting a candidate output (e.g., class, etc.) for a data item based on an embedding of the data item and clusters 410, 420, 430, 440, and 450. By way of example, a data item 460 (e.g., represented as an “X” in FIG. 5) is shown in the embedding space among clusters 410, 420, 430, 440, and 450 based on an embedding of the data item produced by embedding model 310. A pattern recognition technique is used for predicting the appropriate cluster (and, hence, the candidate output (e.g., class, etc.)). For example, a k nearest neighbor (kNN) technique may be applied to determine the nearest neighbors of data item 460 in the embedding space. This technique may determine the distance between data item 460 and the other points in clusters 410, 420, 430, 440, and 450, and identify k nearest neighbors (or k closest points) which reside in the embedding space based on the determined distances to predict the candidate output (e.g., class, etc.) for data item 460. The predicted candidate output (e.g., class, etc.) may be the cluster having a majority of the nearest neighbors. The distance may be determined based on various techniques (e.g., Euclidean distance, Manhattan distance, Hamming distance, etc.).

In the case of using three nearest neighbors (k=3), the three nearest neighbors of data item 460 may be a first data item in cluster 420 (Class 2), a second data item in cluster 420 (Class 2), and a third data item in cluster 430 (Class 3). The predicted candidate output (e.g., class, etc.) may be determined from the cluster having a majority of the nearest neighbors. In this case, since a majority of the nearest neighbors are in cluster 420 (e.g., 2 out of the 3 nearest neighbor data items), the predicted candidate output (e.g., class, etc.) is the class associated with cluster 420 (or Class 2). The k nearest neighbor technique may be applied with any desired number of nearest neighbors (e.g., k may be any suitable values), where any suitable techniques may be used to determine a resulting cluster (e.g., majority, distances to nearest neighbors, etc.).

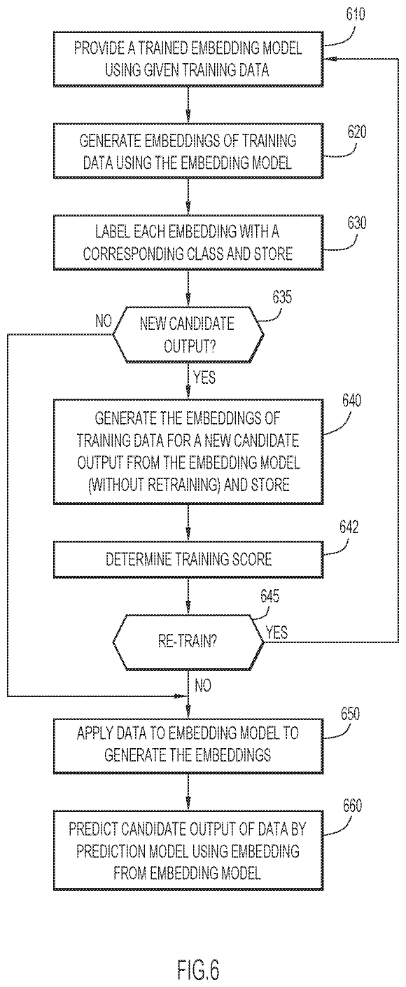

A manner of learning a new aspect by incremental machine learning (e.g., via machine learning module 116 and server system 110 and/or client system 114) according to an embodiment of the present invention is illustrated in FIG. 6. In particular, embedding model 310 (FIG. 3) is produced using a training set for an initial set of candidate outputs (e.g., classes, categories, results, etc.) at operation 610. The set of training data includes a data item and a corresponding known result (e.g., a data item and a known class to which the data item belongs, etc.). The embedding model includes a machine learning model preferably derived from a neural network including input layer 322, intermediate or hidden layers 324, 326, and an output layer 328 (e.g. as described above for FIG. 3). The output layer of the neural network preferably includes a neuron 329 for each candidate output, and indicates the candidate output for corresponding input data. The neural network (including output layer 328) is initially trained on the training set for the initial set of candidate outputs to produce a corresponding candidate output from output layer 328. Once trained, output layer 328 is removed from the neural network, where the remaining portions of the neural network (e.g., input layer 322 and intermediate layers 324, 326) form the embedding model with intermediate layer 326 serving as an embedding layer for producing the embeddings. The elements or dimensions of the embedding correspond to the number of neurons in intermediate layer 326 (e.g., each neuron of the embedding layer provides a value for an element or dimension of the embedding). However, the embedding may include any quantity of dimensions, where any intermediate or other layer of the neural network may provide the embedding.

Once trained embedding model 310 is produced, the set of training data is applied to the embedding model to produce embeddings for data items of the set of training data at operation 620. Each embedding of a data item of the training set is associated (or labeled) with the corresponding known candidate output and stored (e.g., in database system 118) at operation 630. The stored embeddings define the corresponding candidate outputs (e.g., classes, etc.) for prediction model 340. However, the same or a different training set may be used to produce the embeddings defining the candidate outputs.

When a new candidate output (e.g., class, category, result, etc.) is to be added as determined at operation 635, embedding model 310 (FIG. 3) is provided with a set of training data for the new candidate output to generate embeddings representing the new candidate output at operation 640. The set of training data for the new candidate output includes data items corresponding to the new candidate output (e.g., a data item and the new candidate output, etc.) Each embedding of a data item of the training set for the new candidate output is associated (or labeled) with the new candidate output and stored (e.g., in database system 118). Thus, in order to add a new candidate output, incremental machine learning is performed where embedding model 310 produces embeddings defining the new candidate output from a training set for the new candidate output. This avoids the embedding model being retrained (on a large training set encompassing the new and previous candidate outputs), thereby conserving computing and memory resources and significantly increasing the speed of machine learning when a new candidate output is added.

A training score is determined based on the embeddings produced by embedding model 310 from the training set for the new candidate output at operation 642 to determine sufficiency of the incremental machine learning. The training score may be derived from a measure of quality of a cluster formed by the embeddings for the new candidate output. By way of example, a Silhouette method that measures similarity of an object to its own cluster relative to other clusters may be used to determine a score for an embedding for the new candidate output based on the following expression:

score(i)=(b(i)−a(i))/max {a(i),b(i)}

where i represents an embedding for the new candidate output, a(i) is an intra-cluster distance for the embedding relative to other embeddings in the cluster for the new candidate output, b(i) is an inter-cluster distance between the embedding in the cluster for the new candidate output and the embeddings in clusters for other candidate outputs, and max is a maximum function (e.g., providing the greater value of a(i) and b(i)).

For example, an inter-cluster distance, a(i), may be the average distance between an embedding and other embeddings in the cluster for the new candidate output. An inter-cluster distance, b(i), may be the minimum of the average distances for clusters for other candidate outputs. The average distance for a cluster for another candidate output is the average of distances between the embedding in the cluster for the new candidate output and each embedding in the cluster for the other candidate output. The distances may be determined based on various techniques (e.g., Euclidean distance, Manhattan distance, Hamming distance, etc.). The training score may be a combination of the scores for the embeddings for the new candidate output, such as an average of the scores for the embeddings for the new candidate output.

By way of further example, an embedding space may include: Class 1 with points 1A and 1B; Class 2 with point 2A, and a New Class with points 3A, 3B, and 3C. The distances between the points within the New Class may include: 2 between points 3A and 3B; and 4 between points 3A and 3C. In this case, the intra-cluster distance, a(i), for point 3A would be the average of the distances to the other points (3B and 3C) within the New Class or ((Distance 3A to 3B)+(Distance 3A to 3C))/2=(2+4)/2=3. The distances between point 3A and points in the other clusters may be: 12 between point 3A and point 1A of Class 1; 10 between point 3A and point 1B of Class 1; and 12 between point 3A and point 2A of Class 2. The inter-cluster distance, b(i), for point 3A would be the minimum of the average distance for each cluster between point 3A and the points in that cluster, or min ((12+10)/2=11 for Class 1, 12/1=12 for Class 2)=11. The score for point 3A would be (b(i)−a(i))/max {a(i), b(i)}=(11−3)/11=0.72. The training score for the New Class would be the average of the scores for points 3A, 3B, 3C, or (score 3A+score 3B+score 3C)/3.

When the training score does not exceed a threshold as determined at operation 645, the embeddings for the new candidate output are insufficient to enable the candidate output to be added without reconfiguring and retraining of the embedding model. In other words, the embeddings do not sufficiently distinguish the new candidate output from the other candidate outputs. Accordingly, embedding model 310 is produced based on a training set including the training set for the previous candidate outputs and the training set for the new candidate output at operation 610 in substantially the same manner described above (e.g., starting with a machine learning model 320 (or neural network) with an output layer having a neuron corresponding to the new candidate output).

When the training score exceeds the threshold, the embeddings for the new candidate output are sufficient to enable the candidate output to be added without reconfiguring and retraining of the embedding model. In other words, the embeddings sufficiently distinguish the new candidate output from the other candidate outputs. The new candidate output is added to the machine learning system (via incremental machine learning using the embeddings) without retraining of the embedding model, thereby improving the speed of the machine learning and conserving computing and memory resources. Accordingly, when the incremental machine learning is sufficient as determined at operation 645, or an absence of a new candidate output is determined at operation 635, data to be processed is provided to embedding model 310 at operation 650 to generate embeddings for the data.

The embedding produced from embedding model 310 for a data item is provided to prediction model 340 to produce a predicted candidate output as a result for the data item at operation 660 based on clusters of embeddings of data items of the training sets for the candidate outputs formed in the embedding space. The prediction model uses a pattern recognition technique (e.g., k nearest neighbor (kNN), etc.) to predict the candidate output. For example, a k nearest neighbor (kNN) technique may be applied to determine the nearest neighbors of a data item in the embedding space. This technique may determine the distance between the data item and the points in the clusters (representing the candidate outputs including any new candidate outputs), and identify k nearest neighbors (or k closest points) which reside in the embedding space based on the determined distances. The nearest neighbors are used to predict the candidate output (e.g., class, category, result, etc.) as a result for the data item. The predicted candidate output may be the cluster having a majority of the nearest neighbors. The distance may be determined based on various techniques (e.g., Euclidean distance, Manhattan distance, Hamming distance, etc.). The k nearest neighbor technique may be applied with any desired number of nearest neighbors (e.g., k may be any suitable values), where any suitable techniques may be used to determine a resulting cluster (e.g., majority, distances to nearest neighbors, etc.). Additional candidate outputs may be added in substantially the same manner described above.

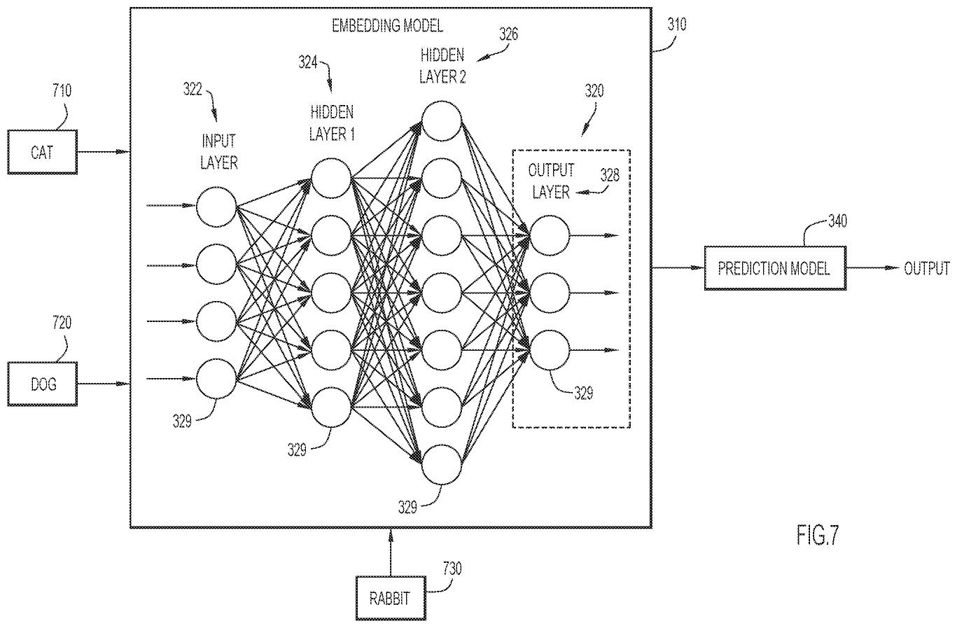

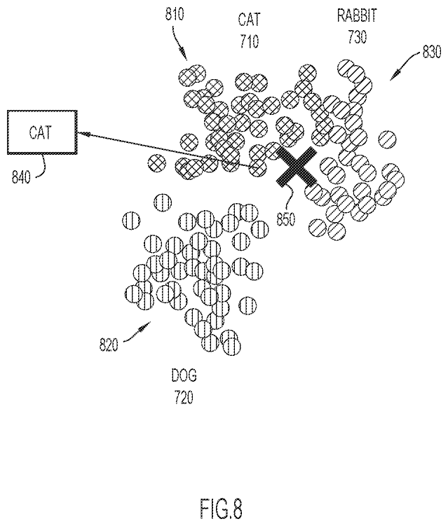

An example of operation of the machine learning system according to an embodiment of the present invention is illustrated in FIGS. 7 and 8. Initially, machine learning system 300 is implemented as a classifier to classify images into classes of categories of cat 710 and dog 720. The machine learning system includes embedding model 310 and prediction model 340 as described above. Embedding model 310 is trained using a training set for the initial set of classes (e.g., cat 710 and dog 720). The set of training data includes a data item (e.g., image, etc.) and a corresponding known result (e.g., a data item and a known class (cat or dog) to which the data item belongs, etc.). The embedding model includes a machine learning model 320 preferably derived from a neural network including input layer 322, intermediate or hidden layers 324, 326, and an output layer 328 (e.g., as described above for FIG. 3). The output layer of the neural network preferably includes a neuron 329 for each class, and indicates the candidate output for corresponding input data. The neural network (including output layer 328) is initially trained on the training set for the initial set of classes to produce a corresponding candidate output from output layer 328. Once trained, output layer 328 is removed from the neural network, where the remaining portions of the neural network (e.g., input layer 322 and intermediate layers 324, 326) form the embedding model with intermediate layer 326 serving as an embedding layer for producing the embeddings.

Once trained embedding model 310 is produced, the set of training data is applied to the embedding model to produce embeddings for data items of the set of training data (e.g., Cat 1 [0.01, 0.00, 0.23, . . . 0.20], Cat N [0.00, 0.02, 0.21, . . . 0.22], Dog 1 [0.02, 0.52, 0.13, . . . 0.38], Dog N [0.02, 0.50, 0.11, . . . 0.40]; for N data items in each class of cat and dog). Each embedding of a data item of the training set is associated (or labeled) with the corresponding known class and stored (e.g., in database system 118).

When a new class, rabbit 730, is to be added, embedding model 310 is provided with a set of training data for the new rabbit class to generate embeddings representing the new class. The set of training data for the new class includes data items (e.g., images, etc.) corresponding to the new class (e.g., a data item and the new class, etc.). Each embedding of a data item of the training set for the new class is associated (or labeled) with the new class and stored (e.g., in database system 118). Thus, in order to add a new class, embedding model 310 generates embeddings defining the new class for the prediction model rather than being reconfigured and retrained for the cat, dog, and rabbit classes, thereby conserving computing and memory resources and significantly increasing the speed of machine learning.

Example data items for the cat, dog, and rabbit classes are shown within a space defined by dimensions of embeddings (FIG. 8). The data items are grouped or clustered within the embedding space, thereby forming clusters corresponding to the cat, dog, and rabbit classes (e.g., cluster 810 is associated with cat class 710, cluster 820 is associated with dog class 720, and cluster 830 is associated with rabbit class 730. A data item within a cluster is assigned to the class associated with that cluster (e.g. a data item in cluster 810 is assigned to cat class 710, a data item in cluster 820 is assigned to dog class 720, and a data item in cluster 830 is assigned to rabbit class 730).

An image 840 of a cat may be provided to embedding model 310 to generate an embedding for the image. The embedding produced from embedding model 310 for the image is provided to prediction model 340 to produce a predicted class for the image based on clusters 810, 820, and 830 of embeddings of data items of the training sets for the cat, dog, and rabbit classes formed in the embedding space. The prediction model may use a k nearest neighbor (kNN) technique to determine the nearest neighbors of the cat image in the embedding space. This technique may determine the k nearest neighbors which reside in the embedding space to predict the class. The predicted class may be determined from the cluster having a majority of the nearest neighbors.

For example, image 840 is represented by a data item 850 (e.g., shown by an “X” in FIG. 8) in the embedding space among clusters 810, 820, and 830 based on an embedding of the image produced by embedding model 310. The k nearest neighbor (kNN) technique may be applied to determine the nearest neighbors of image 840 in the embedding space. In the case of using three nearest neighbors (k=3), the three nearest neighbors of image 840 may be a first data item in cluster 810 (cat class 710), a second data item in cluster 810 (cat class 710), and a third data item in cluster 830 (rabbit class 730). The predicted class may be determined from the cluster having a majority of the nearest neighbors. In this case, since a majority of the nearest neighbors are in cluster 810 (e.g., 2 out of the 3 nearest neighbor data items), the predicted class is the cat class 710 associated with cluster 810.

It will be appreciated that the embodiments described above and illustrated in the drawings represent only a few of the many ways of implementing embodiments for incremental machine learning using embeddings.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any software (e.g., conventional or other server software, conventional or other browser software, conventional or other communications software, machine learning module 116 and interface module 120 of present invention embodiments, etc.). These systems may include any types of monitors and input devices (e.g., keyboard, mouse, voice recognition, etc.) to enter and/or view information.

It is to be understood that the software (e.g., machine learning module 116, interface module 120, etc.) of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., machine learning module 116, interface module 120, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., machine learning models and corresponding configurations and parameters, training data, results, etc.). The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., inputs for machine learning models, new aspects (e.g., new outputs, new classes, classification, outputs from the machine learning models, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., machine learning models, aspects (e.g., types of outputs, classes, etc.), classification, outputs from the machine learning models, etc.).

The embedding model may be derived from any machine learning model (e.g., neural networks, statistical models, etc.). The neural network may be of any type (e.g., feed-forward, recurrent, convolutional, etc.), include any quantity of layers, and any quantity of neurons or nodes in each layer. Any layer of the neural network may serve as the embedding layer producing the embeddings, where the embedding model includes the neural network or any portion of the neural network (e.g., the embedding layer and layers prior to the embedding layer, etc.). The embeddings may be represented by any type of structure (e.g., vector, array, etc.), and may include any quantity of elements or dimensions with any numeric or other values (e.g., alphanumeric, etc.) pertaining to any desired features (e.g., image features, textual features, etc.). Any quantity of embeddings may be generated for a data item (e.g., each embedding is associated with corresponding one or more features of the data item, etc.). The training sets for candidate outputs (including new candidate outputs) may include any quantity of data items of any type (e.g., image, text, video, audio, etc.), and may further include any indications of known results (e.g., known output, known class, known result, etc.). Any conventional or other training techniques may be applied for any quantity of training sets to train or retrain the machine learning model (e.g., backpropagation, etc.).

The prediction model may employ any techniques to predict a candidate output (e.g., machine learning, pattern recognition, kNN, etc.). Any quantity of nearest neighbors may be used for the prediction based on any suitable distances or other similarity measurements (e.g., cosine similarity, etc.). The distance may be determined based on various conventional or other techniques (e.g., Euclidean distance, Manhattan distance, Hamming distance, etc.). The candidate output may be selected based on the nearest neighbors in any fashion (e.g., candidate output associated with a majority of the nearest neighbors, candidate output associated with closest nearest neighbor, distances of nearest neighbors to other clusters, etc.).

The training score may be determined based on any cluster quality metrics and/or distances or other similarity measures (e.g., inter-cluster distance, intra-cluster distance, average distances, cosine similarity, etc.). The distance may be determined based on various conventional or other techniques (e.g., Euclidean distance, Manhattan distance, Hamming distance, etc.). The score for individual embeddings may be combined in any fashion to determine the training score (e.g., average, median, standard deviation, etc.). Further, the embeddings for the new candidate output may combined in any fashion (e.g., average, median, maximum or minimum values for certain features or elements, etc.) to form a representative embedding used to determine the training score. The threshold may be set to any suitable value in any value range to indicate the cluster for the new candidate output is sufficiently distinguished from clusters of other candidate outputs. For example, the inter-cluster distance should be large to distinguish from other clusters, while the intra-cluster distance should be small to provide a cohesive cluster. For the above expression for the training score, a score for an individual embedding towards or near 1.0 indicates a sufficiently distinguishable cluster of embeddings (e.g., for a large inter-cluster distance b(i) and a small intra-cluster distance a(i), the score approaches 1.0). Thus, an example threshold for the training score (e.g., based on the expression above for an average or median of individual embedding scores or a score for the representative embedding, etc.)) may be any value in a range from 0.7 to 1.0 (or similar values for other value ranges based on the manner the individual embedding scores are combined or normalized). However, any suitable value or value range may be used for the threshold.

The present invention embodiments are not limited to the specific tasks or algorithms described above, but may be utilized for learning any types of new aspects (e.g., new outputs, new classes, new groups, new categories, new value ranges, new selections from any group, etc.) for various machine learning systems (e.g., deep learning, classification, pattern matching/recognition, image/video/vision analysis, natural language/text analysis, audio analysis, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of machine learning to produce results encompassing a new output, the method comprising:
training, via a processor, a machine learning model to determine a candidate output from among a plurality of candidate outputs;
generating, via the processor, first embeddings associated with the plurality of candidate outputs from a first set of training data, wherein the first embeddings are produced from an intermediate layer of the trained machine learning model;
generating, via the processor, second embeddings associated with a new candidate output from a second set of training data, wherein the second embeddings are produced from the intermediate layer of the trained machine learning model;
determining, via the processor, a third embedding for input data by the intermediate layer of the trained machine learning model; and
predicting, via the processor, a resulting candidate output for the input data from a group of the plurality of candidate outputs and the new candidate output based on distances for the third embedding to the first and second embeddings.

2. The method of claim 1, wherein the machine learning model includes a classification model, the plurality of candidate outputs includes classes, and the new candidate output includes a new class.

3. The method of claim 1, wherein predicting the resulting candidate output comprises:
determining, from the first and second embeddings, a plurality of embeddings closest to the third embedding; and
determining the resulting candidate output based on candidate outputs associated with the determined plurality of embeddings.

4. The method of claim 3, wherein the resulting candidate output is determined based on a candidate output associated with a majority of the determined plurality of embeddings.

5. The method of claim 1, further comprising:
determining a training score based on the first and second embeddings; and
retraining the machine learning model in response to the training score failing to satisfy a threshold.

6. The method of claim 5, wherein the first embeddings form a plurality of first clusters each associated with a corresponding candidate output and the second embeddings form a second cluster associated with the new candidate output, and determining the training score further comprises:
determining the training score based on distances between the second embeddings within the second cluster and distances between each of the second embeddings and the plurality of first clusters.

7. The method of claim 1, wherein the machine learning model comprises a neural network including an input layer, the intermediate layer, and an output layer for the plurality of candidate outputs, wherein the first, second, and third embeddings are generated by an embedding model, and wherein the embedding model includes the neural network of the trained machine learning model without the output layer.

8. The method of claim 1, wherein the new candidate output is added to the group for predicting the resulting candidate output without retraining the machine learning model.

9. A system for machine learning to produce results encompassing a new output, the system comprising:
at least one processor configured to:
train a machine learning model to determine a candidate output from among a plurality of candidate outputs;
generate first embeddings associated with the plurality of candidate outputs from a first set of training data, wherein the first embeddings are produced from an intermediate layer of the trained machine learning model;
generate second embeddings associated with a new candidate output from a second set of training data, wherein the second embeddings are produced from the intermediate layer of the trained machine learning model;
determine a third embedding for input data by the intermediate layer of the trained machine learning model; and
predict a resulting candidate output for the input data from a group of the plurality of candidate outputs and the new candidate output based on distances for the third embedding to the first and second embeddings.

10. The system of claim 9, wherein the machine learning model includes a classification model, the plurality of candidate outputs includes classes, and the new candidate output includes a new class.

11. The system of claim 9, wherein predicting the resulting candidate output comprises:
determining, from the first and second embeddings, a plurality of embeddings closest to the third embedding; and
determining the resulting candidate output based on candidate outputs associated with the determined plurality of embeddings.

12. The system of claim 11, wherein the resulting candidate output is determined based on a candidate output associated with a majority of the determined plurality of embeddings.

13. The system of claim 9, wherein the at least one processor is further configured to:
determine a training score based on the first and second embeddings; and
retrain the machine learning model in response to the training score failing to satisfy a threshold.

14. The system of claim 13, wherein the first embeddings form a plurality of first clusters each associated with a corresponding candidate output and the second embeddings form a second cluster associated with the new candidate output, and determining the training score further comprises:
determining the training score based on distances between the second embeddings within the second cluster and distances between each of the second embeddings and the plurality of first clusters.

15. The system of claim 9, wherein the machine learning model comprises a neural network including an input layer, the intermediate layer, and an output layer for the plurality of candidate outputs, wherein the first, second, and third embeddings are generated by an embedding model, and wherein the embedding model includes the neural network of the trained machine learning model without the output layer.

16. The system of claim 9, wherein the new candidate output is added to the group for predicting the resulting candidate output without retraining the machine learning model.

17. A computer program product for machine learning to produce results encompassing a new output, the computer program product comprising one or more computer readable storage media having program instructions collectively stored on the one or more computer readable storage media, the program instructions executable by a processor to cause the processor to:
train a machine learning model to determine a candidate output from among a plurality of candidate outputs;
generate first embeddings associated with the plurality of candidate outputs from a first set of training data, wherein the first embeddings are produced from an intermediate layer of the trained machine learning model;
generate second embeddings associated with a new candidate output from a second set of training data, wherein the second embeddings are produced from the intermediate layer of the trained machine learning model;
determine a third embedding for input data by the intermediate layer of the trained machine learning model; and
predict a resulting candidate output for the input data from a group of the plurality of candidate outputs and the new candidate output based on distances for the third embedding to the first and second embeddings.

18. The computer program product of claim 17, wherein the machine learning model includes a classification model, the plurality of candidate outputs includes classes, and the new candidate output includes a new class.

19. The computer program product of claim 17, wherein predicting the resulting candidate output comprises:
determining, from the first and second embeddings, a plurality of embeddings closest to the third embedding; and
determining the resulting candidate output based on candidate outputs associated with the determined plurality of embeddings.

20. The computer program product of claim 19, wherein the resulting candidate output is determined based on a candidate output associated with a majority of the determined plurality of embeddings.

21. The computer program product of claim 17, wherein the program instructions further cause the processor to:
determine a training score based on the first and second embeddings; and
retrain the machine learning model in response to the training score failing to satisfy a threshold.

22. The computer program product of claim 21, wherein the first embeddings form a plurality of first clusters each associated with a corresponding candidate output and the second embeddings form a second cluster associated with the new candidate output, and determining the training score further comprises:
determining the training score based on distances between the second embeddings within the second cluster and distances between each of the second embeddings and the plurality of first clusters.

23. The computer program product of claim 17, wherein the machine learning model comprises a neural network including an input layer, the intermediate layer, and an output layer for the plurality of candidate outputs, wherein the first, second, and third embeddings are generated by an embedding model, and wherein the embedding model includes the neural network of the trained machine learning model without the output layer.

24. The computer program product of claim 17, wherein the new candidate output is added to the group for predicting the resulting candidate output without retraining the machine learning model.
